(19) United States
(12) Patent Application Publication
(10) Pub. No.: US 2022/0203593 A1
(43) Pub. Date: Jun. 30, 2022

(54) CHANGEABLE ROTATABLE COOLING DIE OUTLET END PLATES

(71) Applicant: The Livekindly Company Switzerland GmbH, Pfaffikon (CH)

(72) Inventors: Achim Knoch, Minden (DE); Marco Schlüter, Quakenbrück (DE)

(21) Appl. No.: 17/493,723

(22) Filed: Oct. 4, 2021

Related U.S. Application Data
(60) Provisional application No. 63/133,034, filed on Dec. 31, 2020.
(60) Provisional application No. 63/175,904, filed on Apr. 16, 2021.

(51) Int. Cl. B29C 48/00; B29C 48/25; B29C 48/88

(52) U.S. Cl. CPC B29C 48/0022; B29C 48/911; B29C 48/2566

(57) ABSTRACT

Presented herein are systems and methods directed to cutting an extrudate exiting a cooling die. Embodiments of the system comprise a cooling die with an outlet end, the outlet end containing an outlet for excretion of an extrudate, and one or more plates connected to the outlet end, said plates including a cutting portion which may cut, slash, rip or shape the extrudate that flow through the cutting portion, wherein the one or more plates may be placed in series, and able to be placed in different order configurations and positions. In various embodiments an insert connection device is attached to the outlet end, wherein the one or more plates are connected to the insert connection device, allowing the one or more plates to couple with the outlet end via the insert connection device.

### CROSS REFERENCE TO RELATED APPLICATIONS

This application claims the benefit of U.S. Provisional Application No. 63/133,034 titled “Multichannel Extrudate Cooling System” filed on Dec. 31, 2020. This application also claims the benefit of U.S. Provisional Application No. 63/175,904, titled “Adjustable Cooling Die End Portion Plates” filed on Apr. 16, 2021, both of which are incorporated by reference in their entirety.

### FIELD OF INVENTION

The present technology pertains to customizable cooling die cutting, ripping and shaping plate inserts, endplates, connections and configurations. In particular, but not by way of limitation, the present technology provides Changeable Rotatable Cooling Die Outlet End Plates.

### SUMMARY

In various embodiments the present technology is directed to a system for cutting an extrudate exiting a cooling die, the system comprising: a cooling die with an outlet portion end for excretion of an extrudate,; and one or more plates connected to the outlet portion end, said plates including a cutting portion which may cut, slash, rip or shape the extrudate that flow through the cutting portion, wherein the one or more plates may be placed in series, and able to be placed in different order configurations.

In many embodiments, the system further comprises an insert connection device attached to the outlet end, wherein the one or more plates are connected to the insert connection device, allowing the one or more plates to couple with the outlet end via the insert connection device. The system in various embodiments also includes the insert connection device attached to the outlet end by covering at least a portion of the outlet end. In several embodiments the system also includes one or more plates that are one or more plate inserts placed inside the insert connection device, allowing the one or more plate inserts to couple with the outlet or outlet end of the cooling die.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a diagrammatical representation of a high moisture extrusion (HME) process.

FIG. 2 presents one embodiment of a front view of a round, annular cooling die outlet end.

FIG. 3 presents one view of one embodiment of an insert connection device attached to an outlet end portion of a cooling die.

FIG. 4 presents one embodiment of one side of the insert connection device.

FIG. 5 presents one embodiment of a cooling die cutting plate insert.

FIG. 6 presents one embodiment of two cooling die cutting plate inserts of the type described in FIG. 5 placed on and connected to each other.

FIG. 7 is a diagrammatical representation of one embodiment of a cooling die rip plate insert.

FIG. 8 is diagrammatical representation of one embodiment of two cooling die rip plate inserts attached to each other.

FIG. 9 is presents one embodiment of a cooling die natural cut plate insert.

FIG. 10 presents a diagrammatical representation of one embodiment of two cooling die natural cut plate inserts of the type presented in FIG. 9 placed on and connected to each other.

FIG. 11A provides one view of an insert connection device without any plate inserts attached.

FIG. 11B presents a diagrammatical view of possible connections between the plate inserts to the insert connection device.

FIG. 11C provides one view of an insert connection device with a cutting plate insert, a rip plate insert, and a natural plate insert attached to it.

FIGS. 12A and 12B provide two views of an alternative embodiment of a cooling die insert connection device/connection adapter device with handles.

FIGS. 13A and 13B are two views of an alternative embodiment of a cooling die rip insert plate attached to an insert connection device.

FIG. 14 is a view of a several plate inserts placed on top of each other attached to an insert connection device.

FIG. 15 is a diagrammatical representation of one embodiment of a cooling die rip endplate.

FIG. 16 is a diagrammatical representation of one embodiment of two cooling die rip endplates placed on and connected to each other in a specific configuration.

FIG. 17 is a diagrammatical representation of one embodiment of a cooling die natural cut endplate.

FIG. 18 is a diagrammatical representation of four endplates connected together, two cooling die natural cut endplates on top of two cooling die rip endplates.

FIG. 19 is a front view of an alternative embodiment of a plate insert where the various cutting, ripping and natural cut plate inserts may be incorporated into one plate insert.

### DETAILED DESCRIPTION

Meat analogues and meat alternative products made from plant proteins, plant products, protein concentrates and isolates are gaining in popularity, this is due to a variety of factors including increased environmental consciousness; specifically, the effects the meat industry is known to have on climate change, global warming and the high level of greenhouse gases it produces, and increased health consciousness in the general population with the promotion of low cholesterol, low fat, plant-based protein alternatives as well as increased awareness of animal rights in the developed world.

However, in their current state, meat analogues, meat alternatives and plant-based foods and proteins may suffer from several disadvantages and shortcomings relative to natural meat. Some obvious disadvantages and shortcomings of current alternative meat products are their taste and texture, which are different from and fail to replicate the taste and texture of natural meats. Plant-based alternatives also fail to resemble meats in color, shape, smell and other physical characteristics. Finally, increasing the affordability and availability of these meat analogues and plant proteins are a challenge because producing plant-based meat alternatives are much costlier and more difficult than industrial scale meat production.

Therefore, in the field of meat analogue or meat alternative manufacturing processes, it is generally accepted that there are several goals that the final meat analogue product and the manufacturing process itself must meet; these include alternative meat products that are desirable to the senses, taste good and affordable. Further, the alternative meat products should replicate the texture of natural meats. A meat-like texture allows the bite or crunch of a meat analogue product to feel like that of natural meats to the consumer. Other goals are for the meat analogue to have the same color and/or physically resemble natural meats. Processes making meat analogue products must be scalable, highly efficient, and largely free from manufacturing defects and disruptions. Production line efficiency allows the meat analogue to be affordable and widely available to the general population as a reasonable and realistic alternative to animal proteins.

To realize these goals, the meat analogue industry has moved towards a High Moisture Extrusion (HME) process (referred to herein as “extrusion”, “extrusion process”, “HME process” or “HME”). It is generally accepted that the HME process involves several standardized steps, these steps may be modifiable, altered, added to, or removed depending on the mixtures, recipes and ingredients used as well as the desired product outcome. However, the standard process includes feeding and conveying ingredients into an extruder, mixing, heating and melting these ingredients in the extruder, feeding the mixture into a cooling die which further cools and structures the mixture to achieve and/or maintain the desired meat-like texture and excrete it as a final or semi-finished product (referred to herein as “texturate” or “extrudate”). Post-processing steps may also be added after the HME process, after the cooling die, to the texturate/extrudate, which may include cutting and shearing the protein, or more typically after the extrudate leaves the cooling die, these steps may include cutting, shearing, cooking, freezing, storing, or adding flavors, fats and other food manufacturing and culinary additives. The adding of flavors to the extrudate is usually done before the extrudate is frozen to be packaged.

Traditionally, the cooling systems that are utilized in the cooling die step after extrusion are either flat cooling dies or round/annular cooling dies, also known as cooling nozzles among various other names. Both these types of cooling dies are well known to those skilled in the art. Cooling dies usually have an inlet end, where the extrudate is directed to from the extruder into an inlet, a flow channel for the extrudate to travel through the die as it is being cooled and an outlet end where the texturate/extrudate comes out of an outlet in the outlet end of the die. After the extrudate leaves the cooling die, excreted from an opening at the outlet end of the die, it is usually either cut manually or by a separate automated cutting machine, before being further processed and cooked. Rips may also be made manually or by a separate automated machine to the protein to open the texturate for cooking and allowing the ingress of moisture. However, depending on the size of the cooling die, the excreted texturate can get very wide, or comes out in large pieces making it harder to cut or further process in cutting machines; usually, the larger the cooling die the wider the texturate that comes out.

Current solutions employed in the industry include the outlet being a cross shaped blade or a metallic piece with several dividers that produce flat square-like or rectangular-like shapes, so that the texturate is divided into 4 or 6 strings, if there is another metallic crossblade used as well, which are conveyed out of the cooling die in multiple instead of one string. However, this solution has its own issues; the extrusion process is never perfectly stable, there are always smaller or larger fluctuations in pressure and temperature which create fluctuations in the product's quality, referred to as a varying degree of texturization. This varied product quality directly affects the cutting process that follows cooling and leads to problems at the cutter. For example, if the extrusion process is running for a continued period along with the extruder, the extrudate may have an unstable structure and protein fiber orientation, making it difficult to cut, or flow smoothly through the outlet.

The solutions proposed herein provide for changeable, adjustable, rotatable and customizable plate inserts and/or endplates (collectively referred to as “plates”) attached to a cooling die, which minimize cutting problems from varying degrees of texturization, by generating cut, ripped or shaped strings, ribbons or other forms and shapes of extrudate, or producing certain sizes of extrudate/texturate, appropriately priming it for the cutting step of the HME process following excretion of the extrudate from the cooling die. The solutions presented may also provide a solution to correcting faulty pressure in the outlet end of the cooling die, as well as other parts of the HME process when necessary.

Large size cooling dies usually have outlets/outlet gaps of 10-11 mm wide; wider widths are also possible based on the size of the die. These wider outlet gaps result in a thicker texturate that comes out of the die, resulting in a thick final product. For most applications, thick texturates are not suitable for replicating the feel and size of meats like chicken, and therefore a thinner texturate is required to produce a thinner final product. To reduce thickness of the texturate in larger cooling dies, additional cuts are required to be made to the texturate during or at the end of the cooling process. Solutions such as a crossblade or grid style outlet that make 4-8 cuts in 90° angles do not produce texturate of sufficient thinness. Furthermore, current solutions fail to produce cuts and fibers that resemble meat. And shapes that are produced do not replicate meat-like or natural shapes. Even curved outlet openings, that may include semi-or full circle outlet openings do not produce natural, round, circular or irregular shapes resembling meat. The proposed solutions overcome this problem.

The solutions presented herein will also provide a consistent cutting result at the cutting step(s) after the cooling die. By utilizing the systems described herein, which use plates to provide different combinations of rips, cuts, shapes to produce desired cutting and ripping shapes and patterns allowing the texturate to be cooked, hydrated, boiled, and/or cut more effectively after it leaves the cooling die, as well as provide a texturate with a fibery texture structure, and produce as well as enable the production of natural meat-sized chunks via post- cooling die cutting steps and processes. The proposed solutions may improve the product quality of the texturate by providing an adjustable number of rips on its surface to allow for an optimum level of moisture absorption from further cooking of the extrudate.

In preferred embodiments, neither the plate inserts nor the endplates use sharp blades or knives, but metallic edges with a width of 1-2 mm each. Because these edges are not sharp, the produced effect is opening of the surface of the extrudate or creating several openings in the extrudate. Furthermore, reducing gaps between plates, produces a tighter flow gap that the texturate must flow through, also creating openings in the surface of the texturate as it flows through the plate inserts. The tighter spaces created by the plates may also alter, or increase the overall pressure in the cooling die, the outlet portion of the cooling die, or the HME system as a whole. Thus, plates could also be added in a number, type, or thickness that could help alter, control, maintain or stabilize pressure at certain levels.

The current solutions propose implementing the cutting of the extrudate with plates, preferred embodiments utilize plate inserts attached to the outlet end portion of the cooling die via a connection adapter piece, which in many embodiments includes an internal plate insert system, or alternatively, in other embodiments an external endplate system (the general terms “plate” or “plates” refer to either plate inserts or endplates). The solutions presented in this document are applicable to all types of cooling dies including flat and/or round dies, of multiple sizes, with removable or non-removable cooling cores, single or multi-flow channels, and with or without connection(s) between the cooling core and the outer jacket as present in some in round annular cooling dies.

For most embodiments, various types and combinations of plates may be used by the systems and methods presented herein. Some plates are purposed for cutting, some are ripping plates, some are designed for shaping the extrudate. Each type of plate has a different function in relation to the texturate/extrudate. Cuts are primarily needed to allow the ingress of water in the cooking phase, rips mainly provide natural meat-like fibers in the extrudate, while shaping plates are designed to produce at the cooling die outlet or otherwise aid in the production at the after-cooling die cutting processes specific shapes and natural meat-like chunks, which may include specific shapes such as round, diamond, nugget-like, irregular, square based shapes, angular as well as other shapes that may be desired. One or more plates may be attached in different configurations, these may be of the same or of different types, modifiable based on the desired cuts, rips and shapes to be produced. In many embodiments more than one type of plates are attached to each other to produce different shapes, cuts and rips, the different combinations of plates allow the user to produce different results.

In several embodiments, the systems proposed provide an internal insert system, with an insert connection receptacle device (can be referred to as “insert connection device” or any of “connection adapter”, “connection adapter device”, “insert receptacle device” or “insert receptacle piece”) attached to the outlet end portion of a cooling die, or over it, and in some embodiments secured by a jacket chain, and/or screws, or any other connection system. In various embodiments the internal portion of the insert connection device in turn allows for connections to one or more plate inserts that may include cutting, ripping, or shaping plate inserts. The plate inserts may be attached to the insert connection device through one or more connection interfaces such as one or more of any of an elongated metallic insert piece, screw, bolt, locking chains, rod, locking rod, or other fasteners (collectively referred to herein as “attachment mechanism” or “connection interface”). The connection interface may be placed in an aperture that connects the insert connection device with one or more plates, potentially of various sizes, shapes, and types. The plate inserts may also couple slidably and sealably into the internal portion of the insert connection device. One or more insert plates may be placed together in series. These one or more insert plates may be sealably connected to each other, the outlet, or otherwise the outlet end of a cooling die. The plate inserts are smaller than the insert connection device and therefore usually sit inside the insert connection device. When attached to and/or over a portion of the end of the cooling die, the insert connection device may produce a compact internal space, with tighter gaps between the plate inserts, and between the plate inserts and the outlet of the outlet end of the cooling die, wherein the several plate inserts be attached to the insert connection device shape, cut and/or rip texturate flowing through the outlet end of the cooling die.

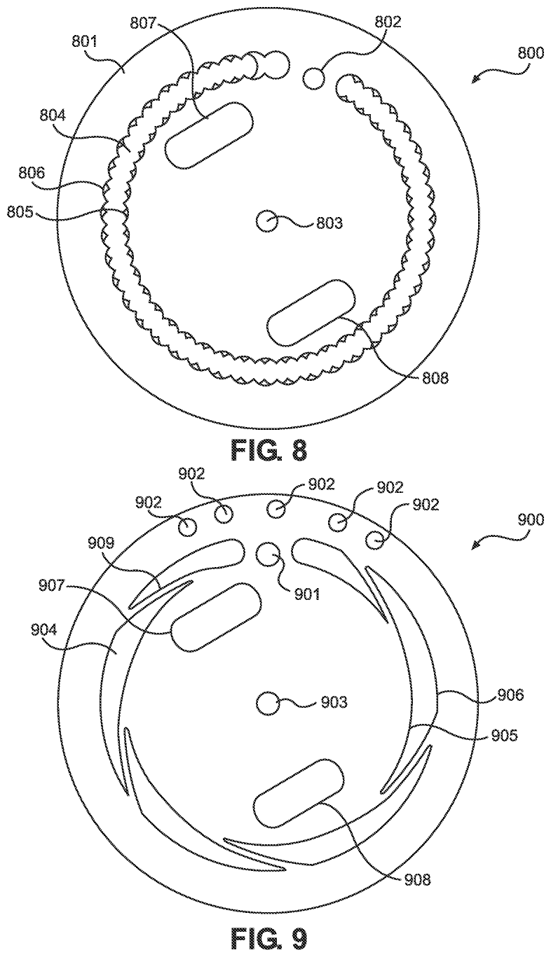

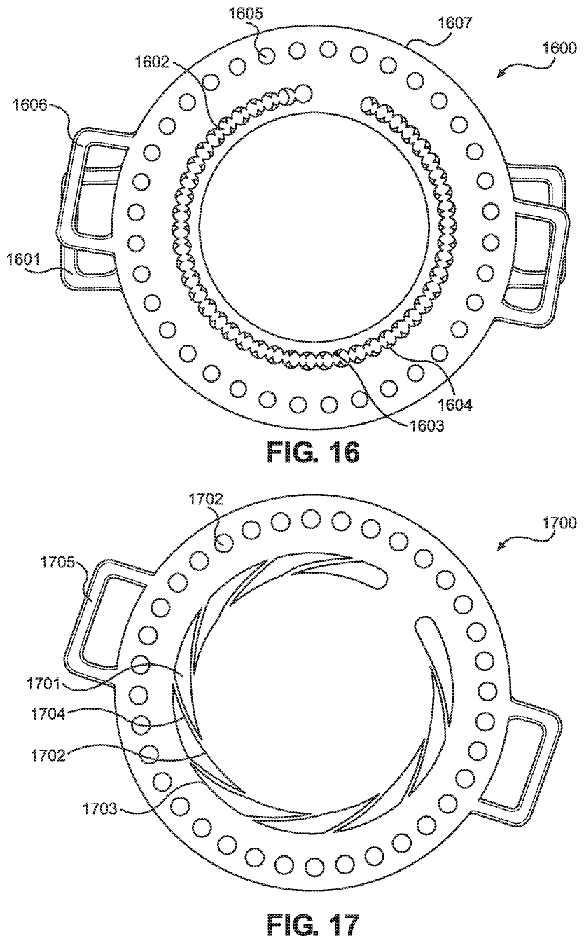

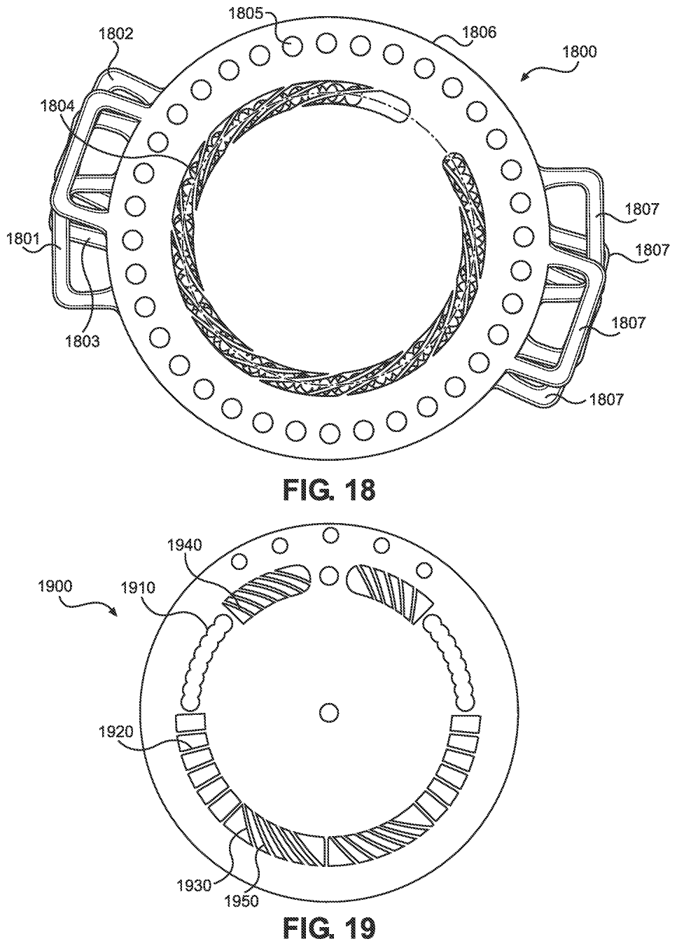

In some embodiments the insert connection device as well as the plate insert(s) may be connected to one or more motors that enable the switching out of one or more plates with other plate(s), and/or rotate the plates to achieve a desired combined shape, or alternatively to change the positions, order or configuration of one or more plate inserts, and in some embodiments, allow plates to quickly switch in and switch out with other different plate inserts during the running of the HME process. Because the HME process is continuously running, the switching and/or rotation of the plates must happen very quickly so that the process is not disrupted. For example, if two cutting plate inserts are connected to each other, with each plate insert capable of making 8 cuts, with the various orientations of each cutting plate insert, 16 separate cuts could be made. Further configurations could be made depending on the angle of rotation of each plate insert, that could provide texturate strings of different sizes. Different types of plate inserts attached to each other may make further variations to the produced string possible; the different combinations of plate types, the number of plates used as well as the different orientations, step joint, rotation angle, twists and/or rotations between different plates attached to each other can create several possible combinations of different numbers, shapes and types of cuts and/or rips and texturate shapes, for example a combination of multiple cooling die rip plate inserts similar to the type in FIGS. 7 and 8, or multiple cooling die rip endplates similar to the type shown in FIG. 16 or 18, are capable of making the produced strings smaller via tighter partially overlapping gaps amongst themselves as the extrudate flows through them from the outlet of a cooling die.

In many embodiments one or more motors, which in some embodiments, may have their control and function be automated, may cause the rotation of different plates into different combinations and orientations to provide for the variety of rips and cuts possible to cut the texturate into different sizes, shapes, and other forms. The motors may also add or remove different plates or types of plates from the current configuration to produce different and new combinations of shapes and sizes of excreted texturate, and with specific orientations to increase, add, or modify the number and type of cuts produced on the texturate.

In some embodiments, the plate inserts for the internal insert system may be removed during the cooling or HME process and/or replaced with other inserts or types of inserts. This may be done automatically, without human intervention or handling. In various embodiments, the internal plate inserts may also be rotated throughout the running HME process, this may be done by automation or manually. Even though the plates are all movable and rotatable, there is no risk of leakage of texturate, because the pressure at the outlet end of the cooling die nearly equals ambient pressure, i.e., an absolute pressure of around 1 bar.

Manual methods of rotating the plate inserts may include using an elongated member, wrench, key, tool, rod, hook or otherwise suitable tool (these collectively referred to as a “rotation tool”) to reach through an opening or aperture of the insert connection device to the plate insert. The plate insert may have sockets, grooves or apertures (collectively referred to herein as a “coupling socket” or “coupling sockets”) to allow placement, clasping, hooking, latching or otherwise coupling of the rotation tool to the plate insert. These coupling sockets may be open only on one side, the side where the tool couples to, to prevent the entry or flow of extrudate. The rotation tool may then be moved to one direction or rotated moving the coupled plate insert along with it. The plate insert may have different notches or specified preset positions or angles that indicate movement, produce sounds, subtle movements, clicks or vibrations (such as those of unlocking a safe) that may be felt by the user of the rotation tool when the plate insert is being rotated to a new position. The plate insert's position relative to the one or more other plates will produce a differently cut, ripped and/or shaped extrudate/texturate.

A plate insert may have gaps, apertures or holes (collectively referred to as “insertion gaps”) to allow the insertion of the rotation tool past the plate insert through the insertion gap to a coupling socket of a second plate insert behind the first plate insert. The rotation tool then may be moved or rotated to move either one or both of the plate inserts, depending on the number and types of rotation tools being utilized. This process can be repeated for as many plates as possible as long as there is an insertion gap allowing a user to reach into a specific plate's coupling socket, allowing the user to rotate one or more plate inserts individually, concurrently, or in sequence.

The pressure inside a cooling die is affected by the types and number of inserts and their position relative to the outlet of the die. Pressure in the outlet portion of the cooling die, which consequently affects the whole system including both the cooling die and the extruder, can be modified and altered based on removing, adding, or using specific or combinations of plate inserts. This means that when pressure is unstable in the cooling die, it may be altered, regulated, or corrected by adding or removing a number of cutting plate inserts that could momentarily increase pressure to create a correction feedback loop in the rest of the process, improving the final product quality of the texturate. While this does not directly affect the throughput of the HME process, or the flow rate of the texturate/extrudate, the speed or velocity of the texturate in at least the outlet end portion of a cooling die may increase. For example, adding multiple ripped cutting plates to or on top of, or in series with each other would have an effect of increasing the pressure and velocity in the cooling die due to reduction of gaps and space, with more plates added, the teeth of each cutting plate overlap further closing available gaps or remaining space.

In various embodiments the internal insert system includes one or more gears that are attached to one or more motors. The gears cause the rotation of each plate insert, either by directly being connected to each plate insert or being connected to a portion of each plate insert that allows controlled rotation to orient each plate to the desired position. This gear-motor system is in turn controlled by remote or direct connection and may be connected to and controlled by a microcontroller or other computing unit and/or device. This computing unit or microcontroller may also be pre-configured to provide different orientations/and or rotations or combinations of plate inserts as required based on the various factors that make up the HME (and cooling) process, these may include and are not limited to the total runtime, pressure, velocity of extrudate, and/or measured temperatures. In many embodiments, the pre-installed plate inserts are not only rotated against each other but also can be re-positioned or added to the configuration. One example could be that one or more plate inserts that are no longer required in the configuration are moved by the system out of the configuration and other plate inserts that are desired are added to the configuration into the specific desired position, with each insert able to be moved around in new positions, or into and/or out of the configuration, during process runtime, or alternatively after a pause has been initiated to allow the insert exchanges to occur. This automated movement in and out of the plates can occur with entry points or openings on the insert connection device which may be placed at the top, bottom or sides of the insert connection device, where plate inserts may be slid in and out replacing one another.

In several embodiments, control arms may be used to move plate inserts in and out of the insert connection device. In various embodiments, the system may also automatically adjust the fit between the inserts to ensure compactness and sealing. In some embodiments, controlling the cutting plates is done remotely. In various embodiments, sensors are deployed inside the cooling die, on the plates, and/or insert connection device to determine the position and/or orientation of each plate. These positions may be displayed to users on a display device, including as part of a control unit, a smart phone, laptop, tablet and the like whereby the functioning of each motor may be controlled by a user to orient and position each plate accordingly.

In several embodiments, an endplate cutting system is implemented whereby endplates are attached to or attached over the outlet of the cooling die. These endplates may be placed individually or placed in combination with each other in various configurations to produce a variety of shapes configurations and/or sizes of extrudate as it comes out the cooling die. Endplates may be removed and/or replaced with various other endplates and configurations. Endplates may also be rotated and/or movable. In various embodiments each endplate is connected to a servomotor that may be placed at the side of the cooling die. The servomotor may be controlled by a user to rotate and/or move each endplate. Endplates may also be rotated manually. Endplates may be fastened onto each other via one or more attachment mechanisms and by loosening the one or more screws, bolts, locking chains, fasteners, or other attachment mechanisms the endplates may be made movable and rotatable, allowing changes in their orientation and changes in the configurations between different plates to produce different extrudate patterns, shapes, cuts and rips. In various embodiments, the one or more screws, bolts, locking chains, other fasteners, and/or attachment mechanisms may be removed allowing removal and/or replacement of one or more endplates.

In several embodiments, both the plate inserts, as well as the adjustable endplates are also able to be switched during the HME process as it is running. This allows the production of new cuts, patterns or shapes of the texturate/extrudate, by switching one or more plate inserts and endplates with one or more other plate inserts or endplates, or alternatively modifying their order or configurations, this allows us to produce extrudate string of different shapes, patterns and cuts without having to stop the extruder and HME process to switch between the different plate inserts and/or endplates, as well as switching plates in and out. In many embodiments, the plates may be rotated via mechanical or automated means.

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

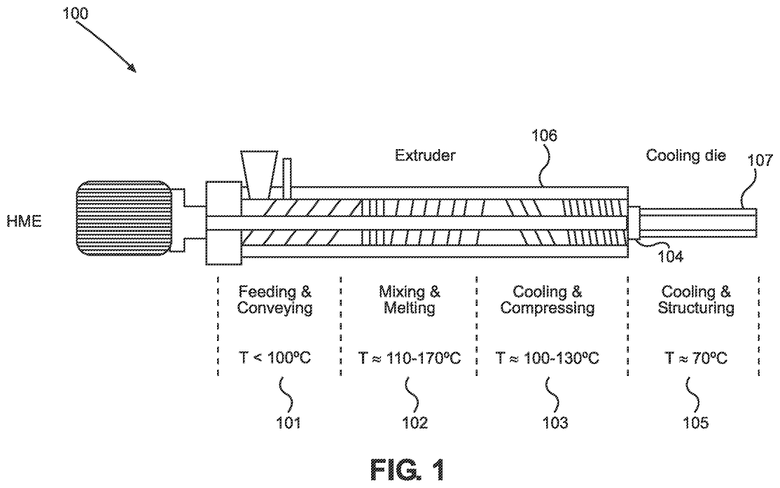

FIG. 1 is a simplified representation of the high moisture extrudate extrusion process 100, which is comprised of feeding material and conveying it 101 into an extruder 106, then mixing, heating and melting the extrudate mixture at 110-170° Celsius (230-338° F.) 102, followed by cooling and compressing the mixture in the extruder at a temperature 100-130° Celsius (230-266° F.) 103. Finally, the extrudate material is fed into the cooling die 107 through the adapter 104 which connects the extruder and cooling die, which cools the extrudate mixture to an outlet temperature of ca. 70° -90° Celsius (158° F.- 194° F.) and structures it 105. This schematic drawing is an example of one possible technical relationship/configuration between the extruder and the cooling die and does not purport to represent all other configurations, relationships, or sizes of either the extruder, the cooling die, or their possible configurations.

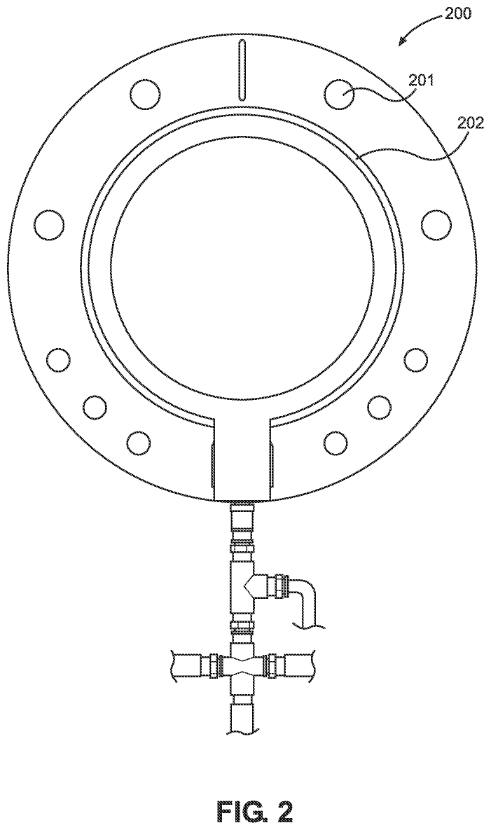

FIG. 2 is a front view of the outlet end 200 of a cooling die. The outlet end 200 contains apertures 201 that may be used to connect with an insert connection device or with endplates via a connection interface/attachment mechanism. The outlet 202 is where the extrudate flows out of the cooling die, and when connected to an insert connection device and plate inserts or with one or more endplates, flows through the gap and then through the plates.

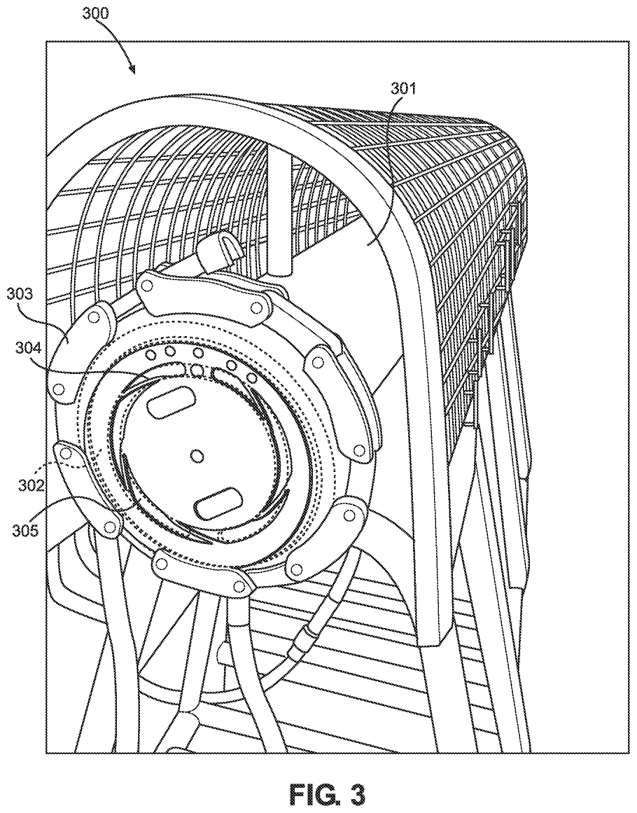

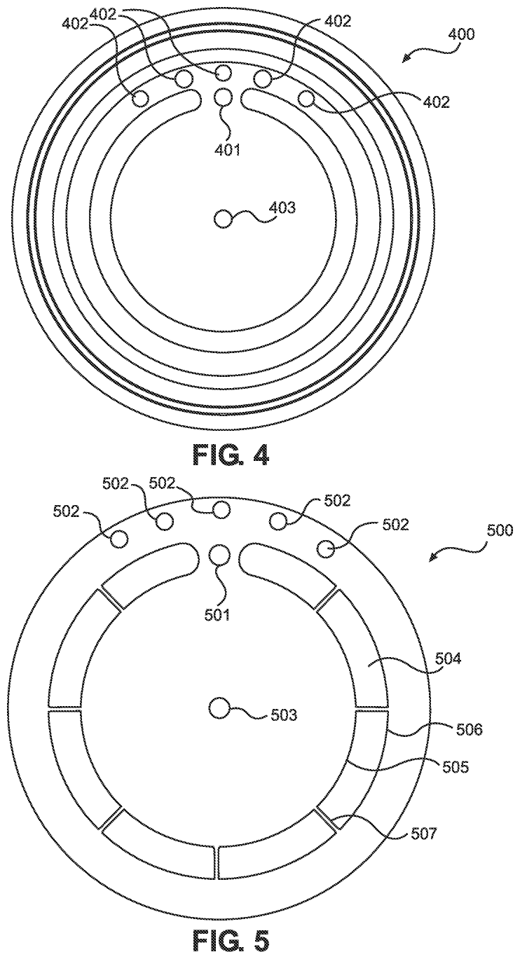

FIG. 3 presents one embodiment of the plate insert system 300, with a cooling die 301 connected to the insert connection device 302 and secured to the outlet end of the cooling die 301 by chain 303. One or more plate inserts 304 are placed inside and connected to the internal side of the insert connection device 302. Plate Insert(s) 304 may cut, rip and shape the texturate before it leaves the system 300 through an outlet 305 of the insert connection device 302. One embodiment of the opposite side of insert connection device 302 is presented in FIG. 4 as 400.

FIG. 4 presents one embodiment of the internal side of an insert connection device 400 which serves as a connection to plate inserts. The insert connection device also serves as the connecting piece between the outlet end portion of a cooling die as well as an attachment for the plate inserts that are placed in and connected to the insert connection device 400. In this embodiment the insert connection device 400 is attached to the plate inserts through an attachment connection piece, such as a screw, bolt or other attachment mechanism such as a locking rod, an elongated member or fastener that connects the plate insert(s) to the insert connection device 400 through connection apertures 401 and 403 or both. In this embodiment, connection aperture 403 fixes the orientational position of the plate inserts relative to the insert connection device 400 and/or other plate inserts. The optional rotation apertures (also referred to as “orientation apertures”) 402 may also be added and placed in various positions across the insert connection device to allow the insert connection device 400 to be connected in different positions to different plate inserts, that may or may not have different attachment hole locations, allowing for different rotations, placements, positions, and configurations for connected plate inserts. Optional orientation apertures may also be used to connect the insert connection device 400 to the outlet end of the cooling die, and secure them together via a connection interface/attachment mechanism. Each of the apertures 401, 402 and 403 connect the insert connection device to plate inserts via an attachment mechanism.

FIG. 5 presents one embodiment of a cooling die cutting plate insert 500. This one cutting plate insert can create 8 separate strings of extrudate that travel through flow gap/cutting portion 504. The cutting plate insert is connected to the insert connection device through connection apertures 501, 503 or both. Optional rotation apertures 502 may also be added and placed in various positions across the plate insert to allow the plate insert to be connected in different positions to the connection adapter device and/or other plate(s), allowing for different rotations, placements, positions, and configurations for each plate insert relative to the insert connection device as well as other plate inserts. Cutting portion 504 is where the extrudate flows into and it is bordered by inner side 505 and outer side 506, the cutting portion 504 formed from the width between inner side 505 and outer side 506. As the texturate flows through cutting portion 504, it runs against the blade or divider 507 cutting the flowing texturate. In preferred embodiments, the blade or divider 507 is blunt, allowing rougher cuts to be formed on the extrudate flowing through. The apertures 501, 502 and 503 may connect the plate insert with an insert connection device or other plate inserts via an attachment mechanism.

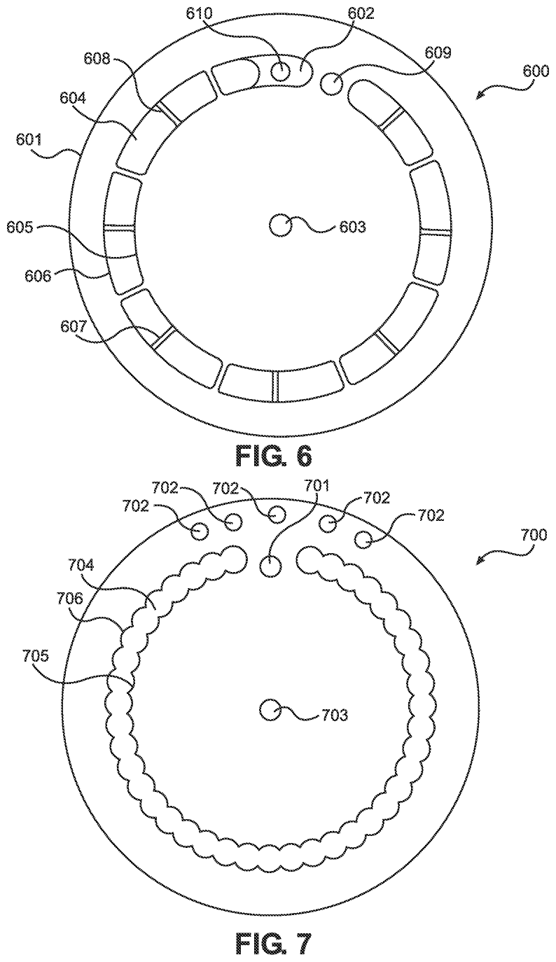

FIG. 6 presents one embodiment of two cutting plate inserts 600 attached and placed on top of or connected to each other. We see the upper cutting plate insert 601 attached over an identical lower cutting plate insert 602. The upper cutting plate insert 601 is rotated by approximately 20° in relation to the lower cutting plate insert 602, the HME product would therefore be cut into 16 instead of 8 strings. Connection aperture 603 is used to connect the two plate inserts 601 and 602 to the connection adapter device and to each other via an attachment mechanism. Cutting portion 604 is bordered by inner side 605 and outer side 606. Blades or dividers 607 of upper plate insert 601, and blades or dividers 608 of lower cutting plate 602 are preferably blunt, able to form rough cuts in the texturate flowing through. Connection aperture 609 of upper plate insert 601 and connection aperture 610 of lower plate insert 602 may be used to fix the plates, via an attachment mechanism, at certain positions relative to each other and the insert connection device to provide for different orientations between them.

FIG. 7 presents one embodiment of a rip plate insert 700. This plate insert may be connected to the connection adapter device through apertures 701, and 703 via an attachment mechanism. The rip plate insert 700 is used to roughen the surface of the texturate, allowing for the ingress of water during optional HME cooking processes. This type of plate insert also creates a natural appearance in the texturate to resemble meat. Unlike the other plate inserts, the texturate is not separated as it flows through rip plate insert 700 and its the cutting portion 704 and the texturate comes out in one piece. Optional rotation apertures 702 may also be added and placed in various positions across the plate to allow the plate to be connected in different positions to the connection adapter device and/or other plate(s), via an attachment mechanism to allow for different rotations, placements, positions, and configurations for each plate insert relative to the insert connection device as well as other plate inserts. The cutting portion 704 is surrounded by an inner side 705 and an outer side 706, the space between them forming the cutting/ripping portion.

FIG. 8 presents one embodiment of two cooling die rip plate inserts attached on top of, or in series with each other 800. The upper or first rip plate insert 801 can be clearly seen along with its optional aperture 802. Connection aperture 803 allows for connection between the two plate inserts and an insert connection device via an attachment mechanism. Additional rip plates on top of each other allow the teeth on both sides of each plate to overlap, as in combined cutting portion 804, which includes the teeth/cutting section of each individual plate insert between inner side 805 and outer side 806. When using only one rip plate insert, usually only a scratch is made in the texturate as it passes through the cutting portion 804 of the plate insert, when additional rip plate inserts are added additional second, third or fourth cuts are made into the texturate. These additional cuts also open the surface of the texturate for the ingress of water and other flavors in the cooking process.

Furthermore, for example, by using 5 or more rip plates together, and at varying orientations in relation to each other, a smaller flow gap 804 is formed, since the inner sides and outer sides of each cutting portion will not be aligned, making the sides (sharp edges/teeth) of the plates to overlap. This tighter gap may increase the pressure in the cooling die and/or other parts of the HME process. Adding or removing plates strategically may also allow control or alteration of the pressure formed in different parts of the cooling die as well as the other parts of the HME process. Insertion gap 807 provides access to the lower plate insert behind it by using a rotation tool and placing it through the insertion gap 807, allowing a user to rotate either the first rip plate insert 801 or other plate insert(s) behind it the tool may reaches. Coupling socket 808 can also be seen to allow coupling of the rotation tool to first rip plate insert 801 to rotate or move it. Both insertion gap 807 and coupling socket 808 can be placed on different areas on the plate inserts, whether closer to the center or further to the rim. There could also be more than one insertion gap 807 or coupling socket 808 on each plate insert. Some plate inserts may have one of insertion gap 807 or coupling socket 808, both, and some will have neither.

FIG. 9 presents one embodiment of a natural cut plate insert 900. Connection apertures 901 and 903 are used to connect the natural cut plate insert 900 to the connection adapter device and/or other plate inserts via an attachment mechanism. This type of natural cut plate is primarily used to enhance the visual appearance of the texturate to make it look more like natural meat. One way it does this is by producing diamond shaped chunks of texturate that may resemble the shape of cut meats such as chicken In a wide cooling die, the strings of texturate produced by natural cut plate insert 900 would be thinner than what would ordinarily be produced by a cooling die of an outlet gap of approximately 10 mm. Optional apertures 902 may also be added and placed in various positions across the plate to allow the plate to be connected in different positions to the connection adapter device and/or other plate(s), via an attachment mechanism, allowing for different rotations, placements, positions, and configurations for each plate insert relative to the insert connection device as well as other plate inserts. Blades or dividers 909 fall within cutting portion 904 and are connected between inner side 905 and outer side 906. As the texturate flows through cutting portions 904, they are separated into naturally looking and sized chunks. Insertion gap 907 provides access to plate inserts that are placed behind or beneath plate insert 900, by using a rotation tool, allowing a user to rotate either the plate insert 900 or and putting the rotation tool through the insertion gap to reach another plate insert. Coupling socket 908 can allow coupling of a rotation tool to first plate insert 900 to rotate or move it to different orientations. Both insertion gap 907 and coupling socket 908 can be placed on different areas on the insert plates, whether closer to the center or further to the rim. There could also be more than one insertion gap 907 or coupling socket 908 on each plate. Some plate inserts may have one of insertion gap 907 and coupling socket 908, have both, and some will have neither one.

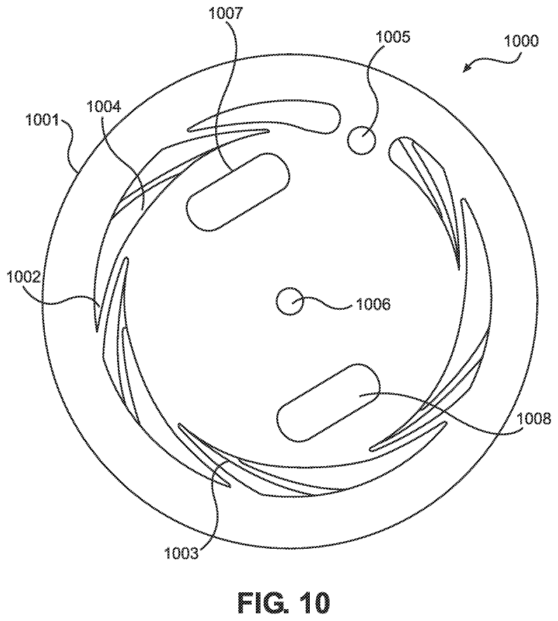

FIG. 10 presents one embodiment of two natural cut plate inserts placed and attached on top of, or in series with each other 1000. The upper natural cut plate insert 1001 has blades or dividers 1002. The bottom or second plate insert's cutting blades or dividers 1003 can be seen from cutting portion 1004 and overlap with blades dividers 1002. Connection apertures 1005 and 1006 may be used to connect one and/or both these plates to the connection adapter device via an attachment mechanism 1107. Insertion gap 1007 provides access to plate inserts that are placed behind or beneath plate insert 1001, coupling socket 1008 may be used to attach to a rotation tool to rotate plate insert 1001 to a different orientation.

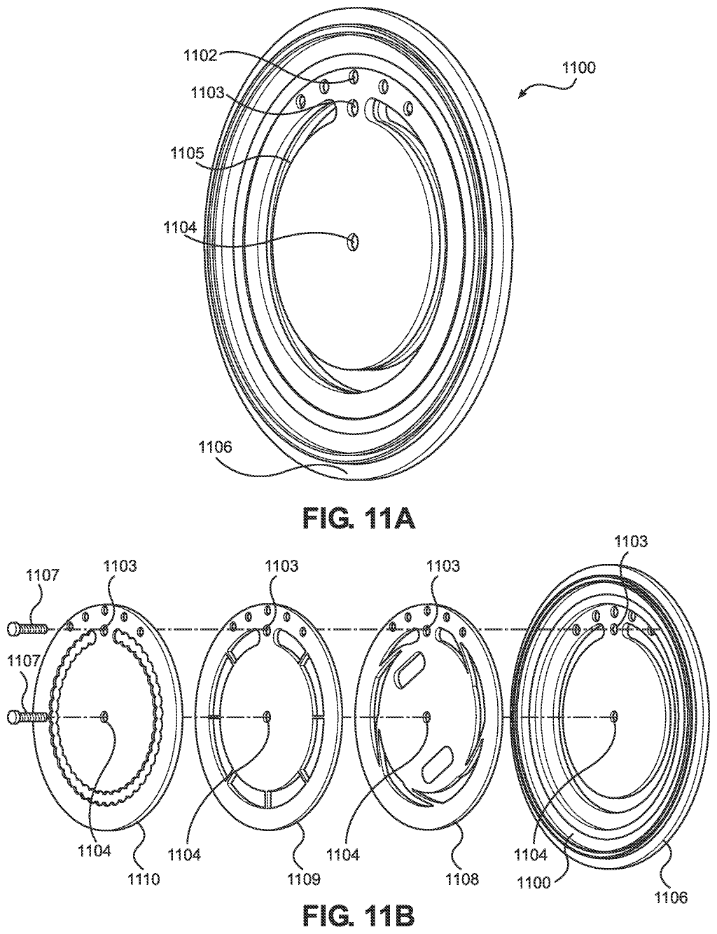

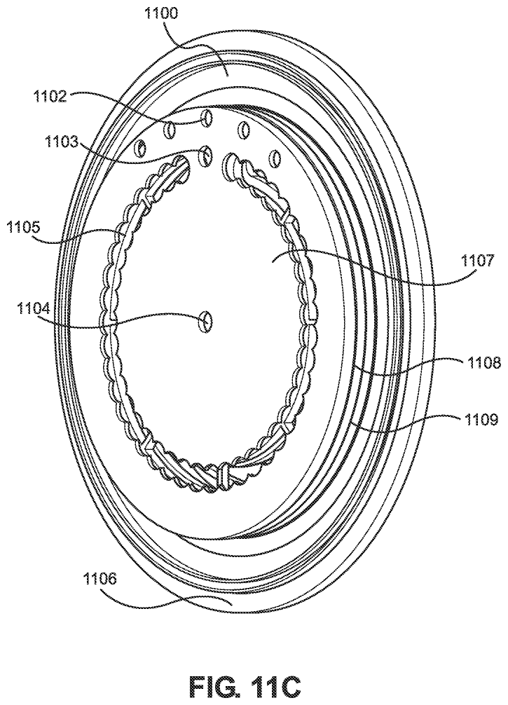

FIG. 11 A presents one view of an insert connection device without any attachments. The insert connection device 1100 has connection apertures 1103 and 1104 where the insert connection device may be connected to plate inserts via an attachment mechanism. Rotation apertures 1102 may be placed around the insert connection device to allow various connections and rotation with plate inserts. The cutting outlet portion of the plate inserts may be seen through insert connection device outlet 1105 where the final extrudate after having gone through the insert plates excretes from. Insert connection device 1100 may be attached to the outlet end of a cooling die either via a chain and/or by overlapping the outer edge 1106 over the outlet end of the cooling die and fixing it in place.

FIG. 11B provides a diagrammatical representation of the fitment of the plate inserts to the insert connection device. In this embodiment the natural rip plate insert 1108, the cutting plate insert 1109 and rip plate insert 1110 may be connected to the insert connection device through one or more attachment mechanisms 1107 and preferably through one or more of connection apertures 1103 and 1104.

FIG. 11C presents a diagrammatical view of an insert connection device connected with or attached to three types of plate inserts: cutting, ripping and natural cut plates. The insert connection device 1100 has connection apertures 1103 and 1104 where the insert connection device may be connected to plate inserts via an attachment mechanism. Rotation apertures 1102 may be placed around the insert connection device to allow various connections and rotation with the plate inserts. The combined cutting portion 1105 of the attached plate inserts are where the extrudate goes through as it exits the cooling die. Insert connection device 1100 may be attached to the outlet end of a cooling die either via a chain and/or by overlapping the outer edge 1106 over the outlet end of the cooling die and fixing it in place. The rip plate 1107 is the first plate out of the three that the extrudate flows through. The second plate 1108 and third plate 1109 are also connected to the insert connection device 1100.

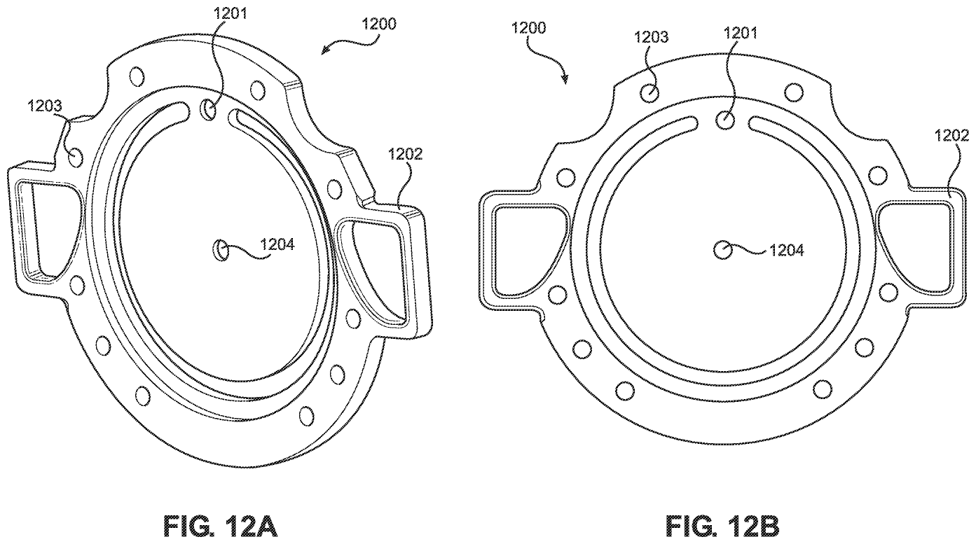

FIGS. 12A and 12B provide two views of another embodiment of an insert connection device 1200, with optional connection aperture 1201 used to connect to plate inserts via an attachment mechanism. This embodiment of the insert connection device/connection adapter device 1200 includes handles 1202 for placement, movement, fitment, and optional rotation, with optional apertures 1203 being used to attach the plate insert to the outlet end of a cooling die via an attachment mechanism.

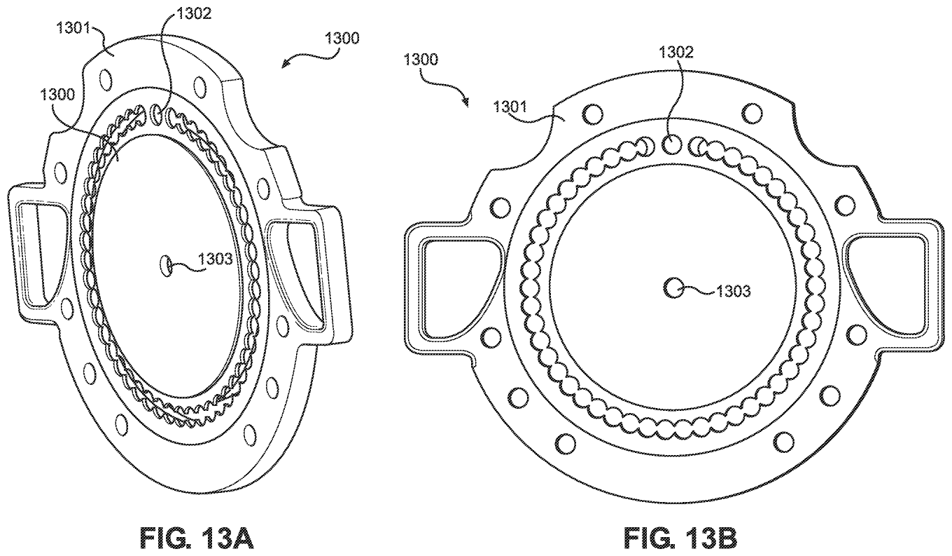

FIGS. 13A and 13B are two views of at least one rip plate insert 1300 inserted into connection adapter device 1301. Plate insert 1300 is able to sealably fit inside insert connection device 1301 and is secured to it with an attachment mechanism used in connection apertures 1302, or 1303 or both. The connection apertures 1302 and 1303 may be used to connect the plate insert 1300 with insert connection device 1301 and/or other cutting plate inserts.

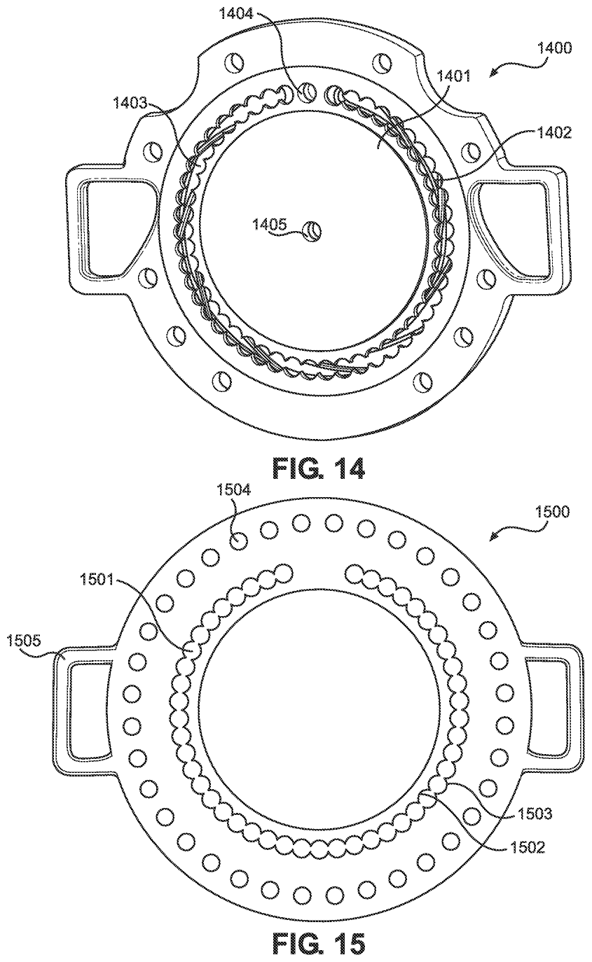

FIG. 14 is a view of multiple plate inserts connected to each other and a connection insert device 1400. A rip plate insert 1401 is attached to a natural cut plate insert 1402. The two plates are securely and sealably connected to each other to ensure no leakages and a tight fit, by using an attachment mechanism through connection apertures 1404, 1405 or both. Only the blades of natural cut plate insert 1402 are viewable. Combined cutting portion 1403 which contains the combined rip plate and natural cut cutting portions overlapping to produce a specific cutting and ripping pattern.

FIG. 15 presents one embodiment of a rip endplate 1500. This endplate is placed at the outlet of a cooling die and contains a cutting portion 1501 bordered by inner cutting portion side 1502 and outer cutting portion side 1503. Several apertures 1504 allow connections between different endplates, and/or between the endplate(s) and the outlet end of the cooling die via an attachment mechanism. There are multiple alignment and orientation options between different endplates connected to each other. The rip endplate 1500 also includes one or more handles 1505 to facilitate the movement and/or rotation of the endplate.

FIG. 16 is art image of one embodiment of die rip endplates placed on top of each other in a specific configuration 1600. First endplate 1607 is placed on top of second or bottom endplate 1601 (handle can be seen), and each of their cutting portions combine to form a combined cutting portion 1602 with overlapping sides from each of the endplates to form an inner side 1603 and outer side 120 that extrudate flows through and is cut or ripped. Apertures 1605 enable several alignment options and orientations between the endplates and a cooling die outlet and allows connection to other plates and/or cooling die outlets via attachment mechanisms. Loosening or removal of the screws, bolts, fasteners or other attachment mechanisms allows movement or rotation of each endplate, preferably via one or more handles 1606 for first endplate 1607 or one or more handles for second endplate 1601.

FIG. 17 is an image of one embodiment of a natural cut endplate 1700. The endplate has a cutting portion 1701. Apertures 1702 allow connections and several alignment options between different endplates, and/or between the endplate(s) and the outlet end of the cooling die via an attachment mechanism. This enables several alignment options and orientations between the endplate 1700 and a cooling die outlet and allows connection to other plates and/or cooling die outlet via the attachment mechanisms. Loosening or removal of the screws, bolts, fasteners or other attachment mechanisms allows movement or rotation of each plate, preferably via one or more handles. Blades or dividers 1704 can be seen within cutting portion 1701, the blades 1704, in preferred embodiments are blunt, and connect to both inner cutting portion side 1702 and outer cutting portion side 1703. The endplate also includes handles 1705.

FIG. 18 is an image of a total of four cooling die endplates 1800, two natural cut endplates 1806 and 1801 placed on top of, or connected to each other and also placed on top of, or connected to two rip endplates 1802 and 1803 forming a combined cutting portion 1804 that contains all the cutting portions of the four endplates producing a combination of cutting and natural rip plate patterns. In this exemplary configuration, top natural rip endplate 1806 is connected to second natural rip endplate 1801, which in turn is connected to cut endplate 1802 that is connected to cut endplate 1803. Apertures 1805 are shown, which enable several alignment options and orientations between the endplates and/or a cooling die or its outlet, to allow connecting the endplates and/or cooling die or cooling die outlet via an attachment mechanism. Loosening or removal of the screws, bolts, fasteners, or other attachment mechanisms allows movement or rotation of each plate, preferably via one or more handles 1807 allowing rotation or removal of any, or all the endplates.

FIG. 19 presents an exemplary embodiment of a plate insert 1900 that contains different portions, segments, or parts, each of which contain one type of blade configuration, whether in the cutting pattern 1920, the ripping pattern 1910 or the natural rip pattern 1930. Rip pattern 1930 has wider spaces between the blades 1950 on the edges of the segment, but smaller spaces between the shaped blades towards the middle of the segment. 1940 however provides narrow spaces on the edges of the segment and wider spaces in the center. This plate insert design would be suitable for cooling dies that may have multiple or separate flow channels for extrudate. This way each channel will have a different cut as it is excreted from the outlet and the rest of the system. This type of multi-pattern plate design may also be incorporated or utilized in endplates.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed.

The various embodiments described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A system for cutting an extrudate exiting a cooling die, the system comprising:
a cooling die with an outlet end, the outlet end containing an outlet for excretion of an extrudate; and
one or more plates connected to the outlet end, said plates including a cutting portion which may cut, slash, rip or shape the extrudate that flow through the cutting portion, wherein the one or more plates may be placed in series, and able to be placed in different order configurations and positions.

2. The system of claim 1, further comprising:
an insert connection device attached to the outlet end, wherein the one or more plates are connected to the insert connection device, allowing the one or more plates to couple with the outlet end via the insert connection device.

3. The system of claim 2 wherein the insert connection device is attached to the outlet end by covering at least a portion of the outlet end and secured by an attachment mechanism.

4. The system of claim 2 wherein the one or more plates are one or more plate inserts that are placed inside the insert connection device, allowing the one or more plate inserts to couple with the outlet end.

5. The system of claim 4 wherein the one or more plate inserts include one or more coupling sockets, wherein the coupling sockets are accessible from outside the insert connection device via a rod, an allen key, a hex key, a wrench or other rotation tool, enabling rotation of the one or more plates from outside the insert connection device.

6. The system of claims 4 wherein a first plate insert of the one or more plate inserts includes one or more insertion gaps to allow access to an another plate insert of the one or more plate inserts from outside the insert connection device via a rod, an allen key, a hex key, a wrench or other rotation tool or device, enabling rotation of the one or more plates from outside the insert connection device.

7. The system of claims 5 wherein a first plate insert of the one or more plate inserts includes one or more insertion gaps to allow access to an another plate insert of the one or more plate inserts from outside the insert connection device via a rod, an allen key, a hex key, a wrench or other rotation tool or device, enabling rotation of the one or more plates from outside the insert connection device.

8. The system of claim 1 wherein the one or more plates are attached directly to the outlet end by one or more of one or more screws, one or more bolts, one or more fasteners, one or more locking chains or one or more other attachment mechanisms.

9. The system of claim 8 wherein the one or more plates may be adjusted, removed or rotated by loosening or removing the one or more screws, the one or more bolts, the one or more fasteners, the one or more locking chains, or the one or more other attachment mechanisms that attach the one or more plates to the outlet end.

10. The system of claim 1 wherein the one or more plates include one or more handles, said handles may be used for removal, rotation or otherwise movement of the one or more plates.

11. The system of claim 1 wherein the cutting portion of the one or more plates includes dividers or blades, wherein the dividers or blade may connect to a first side of the cutting portion and a second side of the cutting portion.

12. The system of claim 11 wherein the dividers or blades are one or more of curved, linear angular, round, circular, open circular, and straight.

13. The system of claim 1 further comprising:
one or more motors connected to the one or more plate inserts to cause them to be individually rotated.

14. An extrudate cooling and cutting system comprising:
one or more cooling channels that facilitate the movement of an extrudate;
a cooling core that adjoins at least a portion of the one or more cooling channels;
an outlet end, with an outlet for the excretion of the extrudate flowing through the one or more cooling channels; and
one or more plates connected to the outlet end, said plates including a cutting portion which may cut, slash, rip or shape the extrudate that flow through the cutting portion, wherein the one or more plates may be placed in series, and able to be placed in different order configurations and positions.

15. The extrudate cooling and cutting system of claim 14, further comprising:
an insert connection device attached to the outlet end, wherein the one or more plates are connected to the insert connection device, allowing the one or more plates to couple with the outlet end via the insert connection device.

16. The system of claim 15 wherein the insert connection device is attached to the outlet end by covering at least a portion of the outlet end and secured by an attachment mechanism.

17. The system of claim 15 wherein the one or more plates are one or more plate inserts that are placed inside the insert connection device, allowing the one or more plate inserts to couple with the outlet end.

18. The system of claim 17 wherein the one or more plate inserts include one or more coupling sockets, wherein the coupling sockets are accessible from outside the insert connection device via a rod, an allen key, a hex key, a wrench or other rotation tool or device, enabling rotation of the one or more plates from outside the insert connection device.

19. The system of claims 17 wherein a first plate insert of the one or more plate inserts includes one or more insertion gaps to allow access to an another plate insert of the one or more plate inserts from outside the insert connection device via a rod, an allen key, a hex key, a wrench or other rotation tool or device, enabling rotation of the one or more plates from outside the insert connection device.

20. The system of claims 18 wherein a first plate insert of the one or more plate inserts includes one or more insertion gaps to allow access to an another plate insert of the one or more plate inserts from outside the insert connection device via a rod, an allen key, a hex key, a wrench or other rotation tool or device, enabling rotation of the one or more plates from outside the insert connection device.

21. The system of claim 14 wherein the one or more plates are attached directly to the outlet end by one or more of one or more screws, one or more bolts, one or more fasteners, one or more locking chains or one or more other attachment mechanisms.

22. The system of claim 21 wherein the one or more plates may be adjusted, removed or rotated by loosening or removing the one or more screws, the one or more bolts, the one or more fasteners, the one or more locking chains or the one or more other attachment mechanisms that attach the one or more plates to the outlet end.

23. The system of claim 14 wherein the one or more plates include one or more handles, said handles may be used for removal, rotation or otherwise movement of the one or more plates.

24. The system of claim 14 wherein the cutting portion of the one or more plates includes dividers or blades, wherein the dividers or blade may connect to a first side of the cutting portion and a second side of the cutting portion.

25. The system of claim 24 wherein the dividers or blades are one or more of curved, linear angular, round, circular, open circular, and straight.

26. The system of claim 14 further comprising:
one or more motors connected to the one or more plate inserts to cause them to be individually rotated.

27. A method for cutting, slashing, ripping and shaping an extrudate, comprising:
moving an extrudate through one or more flow channels of a cooling die device, said flow channels facilitating movement of the extrudate to an outlet end of the cooling die device;
cooling the extrudate as it moves through the one or more flow channels;
moving the extrudate out of the outlet end of the cooling die device; and
flowing the extrudate through one or more plates, the one or more plates including a cutting portion, wherein the flowing through each of the one or more plates includes flowing the extrudate through the cutting portion to cut, slash, rip or shape the extrudate, wherein the one or more plates may be placed in series, and able to be placed in different order configurations, and different positions.

28. The method of claim 27, further comprising:
loosening or removing one or more of an at least one screw, an at least one bolt, an at least one fastener, an at least one locking chain or an at least one other attachment mechanism;
rotating the one or more plate inserts altering their configuration to alter one or more of the cut, slash, rip, and shape of the extrudate; and
tightening or replacing the at least one screw, the at least one bolt, the at least one fastener, the at least one locking chain or the at least one other attachment mechanism.

29. The method of claim 27 wherein the cutting portion of the one or more plates includes blades or dividers connecting a first cutting portion side to a second cutting portion side.

30. The method of claim 29, wherein the one or more plates comprise a first plate with curved dividers or blades, and a second plate with straight dividers or blades placed in series.
